(19) United States
(12) Patent Application Publication
(10) Pub. No.: US 2026/0352418 A1
(43) Pub. Date: Nov. 5, 2026

(54) FEEDBACK AND CSI REQUESTING

(71) Applicant: Nordic Semiconductor ASA, Trondheim (NO)

(72) Inventors: Karol SCHOBER, Oulu (FI); Mauri NISSILÄ, Oulu (FI)

(73) Assignee: Nordic Semiconductor ASA, Trondheim (NO)

(21) Appl. No.: 19/100,089

(22) PCT Filed: Aug. 8, 2023
(86) PCT No.: PCT/EP2023/071979

§ 371 Date: Jan. 30, 2025

(30) Foreign Application Priority Data
Aug. 9, 2022 (GB) 2211588.5

(51) Int. Cl. H04L 5/00; H04L 1/1812; H04L 1/1829

(52) U.S. Cl. CPC H04L 5/0055; H04L 1/1812; H04L 1/1864; H04L 5/001; H04L 5/0057; H04L 5/0094

(57) ABSTRACT

A receiver device is provided which is arranged to receive a data packet from a transmitter device comprising a control portion and a payload portion, said control portion comprising a feedback request indicator. The receiver device is arranged to detect the feedback request indicator, to attempt to decode the payload portion of the data packet, to transmit an acknowledgement to the transmitter device if said feedback request indicator indicates that an acknowledgement is requested for said data packet, and to process said data packet without transmitting an acknowledgement if said feedback request indicator indicates that an acknowledgement is not requested for said data packet.

### BACKGROUND OF THE INVENTION

The present invention relates to feedback in communication systems.

A common issue in wireless communications between two devices (e.g. between a base station and a user device) is that of detecting and correcting for errors in transmitted data, e.g. due to interference or fading in the physical communication channel between the two devices.

Some radio protocols utilise hybrid automatic repeat request (HARQ) techniques to detect and correct for errors, in which a receiving device provides feedback to a transmitting device to indicate if a data packet has been (or can be) successfully decoded. HARQ feedback consists of a positive acknowledgment (ACK) if decoding is or will be successful and a negative acknowledgment (NACK) if decoding is or will be unsuccessful. A negative acknowledgement triggers the transmitting device to re-transmit the data. In the NB-IoT communication protocol, an evolved Node B (eNB) can specify particular OFDM time and frequency resources to be used by User Equipment (UE) for providing HARQ feedback.

The use of acknowledgement signals such as HARQ feedback can help to ensure reliable communication between two devices. However, having to wait for an acknowledgement can stall the transmission of further data packets. This issue can be particularly problematic when the two communicating devices are far apart due to increased transmission latencies. However, the effects of noise and interference may be particularly significant in long-range communications, so simply disabling HARQ feedback may necessitate very conservative operation with low data rates.

Some devices can handle multiple HARQ processes in parallel, which can mitigate stalling in some situations but requires additional resources.

An improved approach may be desired.

### SUMMARY OF THE INVENTION

According to a first aspect of the present invention there is provided a receiver device arranged:
to receive a data packet from a transmitter device comprising a control portion and a payload portion, said control portion comprising a feedback request indicator;
to detect the feedback request indicator;
to attempt to decode the payload portion of the data packet;
to transmit an acknowledgement to the transmitter device if said feedback request indicator indicates that an acknowledgement is requested for said data packet; and
to process said data packet without transmitting an acknowledgement if said feedback request indicator indicates that an acknowledgement is not requested for said data packet.

According to a second aspect of the present invention there is provided a communication system comprising:
a transmitter device; and
a receiver device;
   wherein the transmitter device is arranged to:
transmit a data packet to the receiver device, said data packet comprising a control portion and a payload portion, said control portion comprising a feedback request indicator; and
   wherein the receiver device is arranged:
to receive said data packet from the transmitter device;
to detect the feedback request indicator;
to attempt to decode the payload portion of the data packet;
to transmit an acknowledgement to the transmitter device if said feedback request indicator indicates that an acknowledgement is requested for said data packet; and
to process said data packet without transmitting an acknowledgement to the transmitter device if said feedback request indicator indicates that an acknowledgement is not requested for said data packet.

According to a third aspect of the present invention there is provided a method of operating a communication system, said method comprising:
a transmitter device transmitting a data packet to a receiver device, said data packet comprising a control portion and a payload portion, said control portion comprising a feedback request indicator; and
the receiver device:
   receiving said data packet;
   detecting the feedback request indicator;
   attempting to decode the payload portion of the data packet;
   transmitting an acknowledgement to the transmitter device if said feedback request indicator indicates that an acknowledgement is requested for said data packet; and
   processing said data packet without transmitting an acknowledgement to the transmitter device if said feedback request indicator indicates that an acknowledgement is not requested for said data packet.

Thus, it will be appreciated by those skilled in the art that the feedback request indicator allows feedback to be requested dynamically at a packet level, providing a communication system with improved flexibility. For instance, the transmitter device can request feedback with the feedback request indicator when transmitting critical data packets (e.g. resource control signalling) and disable feedback when transmitting non-critical data packets, mitigating stalling whilst still ensuring that critical data packets are properly received. In many communication systems, most of the traffic can be classed as non-critical, allowing for significant improvements in performance.

The receiver device may attempt to decode the entire payload portion of the data packet prior to transmitting the acknowledgment. Alternatively, the receiver device may only attempt to decode part of the payload portion prior to acknowledgment. In some embodiments, attempting to decode the payload portion may comprise first assessing one or more error-detecting portions of the data packet (e.g. one or more parity bits or check bits). If the error-detecting portions indicate that successful decoding is possible, the receiver device may proceed to a full decoding attempt. Conversely, if the error-detecting portions indicate that successful decoding is not possible, the receiver device may skip a full decoding attempt.

The receiver device may be arranged to transmit the acknowledgement to the transmitter device if said feedback request indicator indicates that an acknowledgement is requested for said data packet and said attempt to decode the payload portion is or will be successful (i.e. if one or more error-detecting portions of the data packet or a full decoding attempt indicates that the data packet has been successfully received). In other words, the acknowledgement may be a positive acknowledgment. In such cases, the transmitter device may interpret an absence of acknowledgement when one has been requested as a negative acknowledgement, indicating that part or all of the packet was not successfully received.

The receiver device may be arranged to transmit the acknowledgement to the transmitter device if said feedback request indicator indicates that an acknowledgement is requested for said data packet and said attempt to decode the payload portion is or will be unsuccessful (i.e. if one or more error-detecting portions of the data packet or a full decoding attempt indicates that the data packet has not been successfully received). In other words, the acknowledgement may be a negative acknowledgment. The transmitter device may be arranged to re-transmit the packet in response to a negative acknowledgement.

The receiver device may be arranged to send both positive and negative acknowledgements as appropriate. In a set of embodiments, the receiver device is arranged to transmit a positive acknowledgement to the transmitter device if said feedback request indicator indicates that an acknowledgement is requested for said data packet and said decoding attempt is or will be successful, and to transmit a negative acknowledgement to the transmitter device if said feedback request indicator indicates that an acknowledgement is requested for said data packet and said decoding attempt is or will be unsuccessful.

The acknowledgement transmitted by the receiver device may consist of a single acknowledgement bit. For instance, the acknowledgement bit having a first state (e.g. “1”) may indicate appositive acknowledgment, and the acknowledgement bit having a second state (e.g. “0”) may indicate a negative acknowledgement. The acknowledgement may comprise a hybrid automatic repeat request (HARQ) acknowledgement. A positive acknowledgement may comprise a HARQ ACK, and a negative acknowledgment may comprise a HARQ NACK.

In a set of embodiments, the receiver device (and the transmitter device) is arranged to communicate using Orthogonal Frequency Division Multiplexing (OFDM). The data packet may comprise an OFDM packet made up of symbols spanning a plurality of time slots and frequency subcarriers. In a set of embodiments the receiver device is arranged to operate according to a 3GPP Long Term Evolution (LTE) communication protocol, such as a Narrowband Internet of things (NB-IoT) protocol.

The transmitter and receiver devices may be arranged to perform two-way communication, i.e. they may each comprise transceiver devices. In other words, in a set of embodiments, the transmitter device comprises a first transceiver device and the receiver device comprises a second transceiver device. In such embodiments the first transceiver device may also be arranged to receive and acknowledge data packets from the second transceiver device in a similar manner.

The transmitter device may comprise a base station, e.g. an LTE evolved Node B (eNB) such as NB-IoT eNB. The receiver device may comprise an end user device, e.g. LTE User Equipment (UE) such as NB-IoT UE. The data packet transmitted by the receiver device may comprise a downlink data packet. The acknowledgment may be transmitted in an uplink data packet. Conversely, the receiver device may comprise a base station, such as an LTE evolved Node B (eNB) and the transmitter device may comprise an end user device such as LTE User Equipment (UE).

The transmitter may be arranged to wait for an acknowledgement of a given data packet (if one has been requested) before sending further data packets (i.e. in case re-transmission of the data packet is necessary). In some embodiments, the communication system may be arranged to support multiple acknowledgement processes in parallel, i.e. in which acknowledgments for several packets can be outstanding at the same time. However, the applicant has recognised that supporting multiple parallel acknowledgement processes may require additional hardware resources and increase energy use. Therefore, in a set of embodiments the receiver device and/or the transmitter device is arranged to support only a limited number of parallel acknowledgment processes. For instance, the receiver device and/or the transmitter device may be arranged to support only one acknowledgment process at a time, or to support only two parallel acknowledgment processes.

In a set of embodiments, the communication system is a non-terrestrial communication system (i.e. forming part of a non-terrestrial network (NTN). The transmitter device may be provided by a satellite, e.g. in low earth orbit. The receiver device may be a terrestrial device (i.e. located on or near to the surface of the earth) arranged to receive data packets from a transmitter device provide by a satellite. For instance, the receiver device may be an NTN IoT device. The advantages of the present invention may be particularly apparent in non-terrestrial communication systems where transmission distances (and thus propagation latencies) can be large and thus where stalling issues might typically be most common (e.g. when a system runs out of acknowledgment processes to use).

In a set of embodiments, the control portion comprises an LTE physical downlink control channel (PDCCH), e.g. an NB-IoT physical downlink control channel (NPDCCH). The feedback request indicator may comprise the ACK/NACK field of DCI format N1. Conventionally, the ACK/NACK resource field simply indicates which resources to use for HARQ feedback, but the applicant has recognised that it may be beneficially repurposed to provide dynamic feedback operation.

The acknowledgement (positive or negative) may be sent as part of a subsequent data packet sent from the receiver device to the transmitter device. For example, the acknowledgement may be sent as part of uplink control information (UCI) in an LTE physical uplink control channel (PUCCH) or a physical uplink shared channel (PUSCH), e.g. an NB-IoT physical uplink control channel (NPUCCH) or a physical uplink shared channel (NPUSCH). In a set of embodiments the acknowledgement is sent using NB-IoT physical uplink shared channel (NPUSCH) format 2.

The acknowledgement (positive or negative) may be sent using fixed (i.e. predetermined) time and frequency resources (e.g. at a predetermined time and frequency offset in an OFDM packet structure). However, in a set of embodiments, the feedback request indicator specifies time and/or frequency resources with which the acknowledgement is to be transmitted. For instance, the feedback request indicator may indicate a frequency and/or time offset in an OFDM packet structure at which the acknowledgement should be transmitted. The feedback request indicator may identify a subcarrier and/or a time slot in which the acknowledgement (e.g. the uplink control signal carrying an ACK/NACK message) is to be transmitted. Allowing dynamic allocation of time and/or frequency resources for the acknowledgement may improve the flexibility and performance of the communication system. In some embodiments, the feedback request indicator may be arranged only to specify time and/or frequency resources and the receiver device is arranged to interpret a range of time and/or frequency resources (e.g. a single time and/or frequency resource) specified by the feedback request indicator as an indication that feedback is not requested. This may facilitate the application of the invention to existing communication protocols, because an existing control signal, e.g. the ACK/NACK resource field, can be repurposed for additional acknowledgment control signalling without significant transmitter-side changes.

As explained above, enabling the transmitter device to request packet acknowledgements dynamically provides increased flexibility and can mitigate communication stalling due to long round-trip acknowledgment latencies. However, because every packet may not be acknowledged, the communication system may be more vulnerable to data being lost due to poor communication channel conditions. In some embodiments, feedback may be requested only for a small proportion of packets (e.g. less than 10% of packets). Therefore, in a set of embodiments the receiver device is arranged:
to determine channel quality information regarding a communication channel between the transmitter device and the receiver device; and
to transmit said channel quality information to the transmitter device if said feedback request indicator indicates that channel quality information is requested.

Thus, the transmitter device is able to request and receive updated information on the channel conditions dynamically. This may allow the transmitter device to identify when channel conditions are deteriorating so that it can take appropriate action (e.g. requesting packet feedback more frequently). The transmitter device may be arranged to implement additional error compensation in response to the channel quality information transmitted from the receiver device, e.g. by decreasing the code rate of the data packet. For instance, the transmitter device may be arranged to request feedback for the next data packet using the feedback request indicator if the channel quality information indicates that channel conditions have deteriorated or are deteriorating. For example, the transmitter device (or associated network systems) may classify the receiver as mobile based on the channel quality information and previous communications.

The receiver device may be arranged to determine the channel quality information by measuring a signal-to-noise ratio (SNR) of received signals (e.g. common downlink signals, such as narrowband reference signals (NRS) or synchronization signals).

The channel quality information may comprise various different indications of channel quality. The channel quality information may comprise an absolute indication or measure of channel quality, e.g. a value indicating a channel quality on a numeric scale. For instance, the channel quality information may comprise a SNR of received signals. Additionally or alternatively, the channel quality information may comprise a relative or differential indication or measure of channel quality, e.g. a channel quality relative to a previous report on channel quality or a channel quality trend (e.g. indicating if channel quality is improving or deteriorating). The channel quality information may, for instance, identify whether the SNR of received signals is increasing or decreasing and may optionally indicate a magnitude of this increase or decrease. The channel quality information may comprise an LTE Channel State Information (CSI) report.

The channel quality information may consist of a single bit. For instance, the bit having a first state (e.g. “1”) may indicate “good” or “improving” channel quality and the bit having a second state (e.g. “0”) may indicate “poor” or “deteriorating” channel quality.

Alternatively, in a set of embodiments the channel quality information comprises a plurality of bits, e.g. to provide more detail on the quality of the communication channel. The channel quality information may comprise a plurality of bits encoded using orthogonal cover coding (OCC), e.g. encoded on a bit or symbol sequence sent to the transmitter. For instance, two bits may be encoded using OCC on top of a bit or symbol sequence carrying uplink control information (e.g. uplink control channel symbols).

As with the acknowledgement, the channel quality information may be sent as part of a subsequent data packet sent from the receiver device to the transmitter device. This may be sent using fixed (i.e. predetermined) time and frequency resources (e.g. at a predetermined time and frequency offset in an OFDM packet structure). However, in a set of embodiments, the feedback request indicator specifies time and/or frequency resources with which the channel quality information is to be transmitted. For instance, the feedback request indicator may indicate a frequency and/or time offset in an OFDM packet structure at which the channel quality information should be sent. The feedback request indicator may identify a subcarrier and/or a time slot in which the channel quality information (e.g. an uplink control signal carrying the channel quality information) is to be transmitted. Allowing dynamic allocation of time and/or frequency resources for the channel quality information may improve the flexibility and performance of the communication system.

The receiver device may be arranged to transmit said channel quality information with the acknowledgement. For instance, the feedback request indicator may indicate that channel quality information and an acknowledgement is requested for the data packet. The feedback request indicator may indicate that one, both or neither of channel quality information and an acknowledgement is requested. In other words, for some packets the transmitter device may request one of: no feedback (no acknowledgment and no channel quality information); an acknowledgment but no channel quality information; channel quality information but no acknowledgment; or an acknowledgment and channel quality information (i.e. full feedback).

The receiver device may be arranged to combine the channel quality information and the acknowledgement, e.g. to enhance communication efficiency. For instance, the receiver device may be arranged to encode the channel quality information and the acknowledgement into a single transmission. In a set of embodiments the receiver device is arranged to encode the channel quality information with the time and/or frequency resources used to transmit the acknowledgement (e.g. to encode the channel quality information with at least two time and/or frequency resources that can be used to transmit the acknowledgment). Accordingly, the transmitter may be arranged to decode the channel quality information by detecting which time and/or frequency resources the acknowledgment has been transmitted on (e.g. with which subcarrier and/or in which time slot the acknowledgment has been transmitted). For instance, the receiver device may be arranged to transmit the acknowledgement using one or more specific time and/or frequency resources that identify the channel quality information. In other words, the receiver device may be arranged to select the time and/or frequency resources to use for the acknowledgment based on the channel quality. The transmitter device may be arranged to perform blind decoding in a set of time and/or frequency resources (e.g. a set the transmitter device specified using the feedback request indicator) to detect the acknowledgment and/or to decode channel quality information.

In a set of embodiments, the receiver device is arranged to transmit the acknowledgement using a first set of time and/or frequency resources to indicate a first channel quality indication and to transmit said acknowledgement using a second set of time and/or frequency resources to indicate a second channel quality indication. For instance, the feedback request indicator may indicate that an acknowledgement and channel quality information are requested, and may identify a pair of time and/or frequency resources with which to transmit the acknowledgement and channel quality information. The receiver may then be arranged to transmit the acknowledgment using a first of the pair of resources to indicate a first channel quality (e.g. to indicate that channel quality is improving) and to transmit the acknowledgment using a second of the pair of resources to indicate a second channel quality (e.g. to indicate that channel quality is deteriorating). In other words, the receiver device may be arranged to signal channel quality information to the transmitter device by sending an acknowledgement (e.g. HARQ ACK/NACK feedback) with particular resources.

Features of any aspect or embodiment described herein may, wherever appropriate, be applied to any other aspect or embodiment described herein. Where reference is made to different embodiments, it should be understood that these are not necessarily distinct but may overlap.

### BRIEF DESCRIPTION OF THE DRAWINGS

One or more non-limiting examples will now be described, by way of example only, and with reference to the accompanying figures in which:

FIG. 1 is a schematic diagram of a radio communication system according to an embodiment of the present invention;

FIG. 2 illustrates a downlink data packet for use in embodiments of the present invention;

FIG. 3 illustrates a uplink data packet for use in embodiments of the present invention;

FIG. 4 illustrates information indicated by the feedback request indicator field in one embodiment of the present invention; and

FIG. 5 illustrates information indicated by the feedback request indicator field according to another embodiment of the present invention.

### DETAILED DESCRIPTION

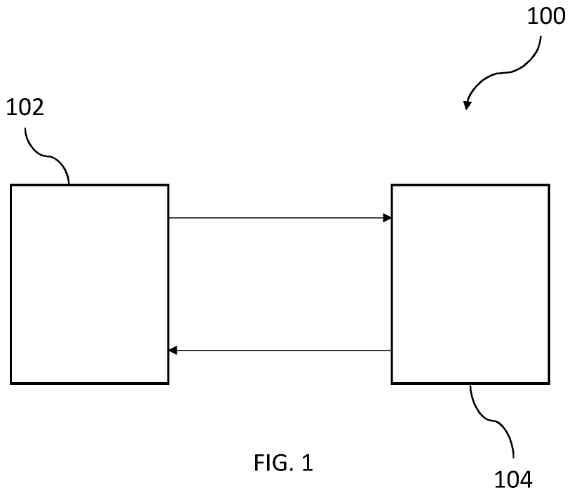

FIG. 1 illustrates a radio communication system 100 which operates according to the NB-IoT communication protocol. The system 100 comprises an evolved Node B (eNB) 102 and user equipment (UE) 104. In this example, the communication system 100 forms part of a Non-Terrestrial Network (NTN), where the eNB 102 is provided by a satellite (e.g. a low earth orbit satellite) and the UE 104 is a terrestrial NTN IoT device (e.g. a sensor device at or near ground level).

In use, the eNB 102 transmits data to the UE 104 using downlink physical channel data packets and the UE 104 transmits data to the eNB 102 using uplink physical channel data packets. Downlink and uplink data is sent using OFDM across 12 subcarriers of 3.75 kHz or 15 kHz each.

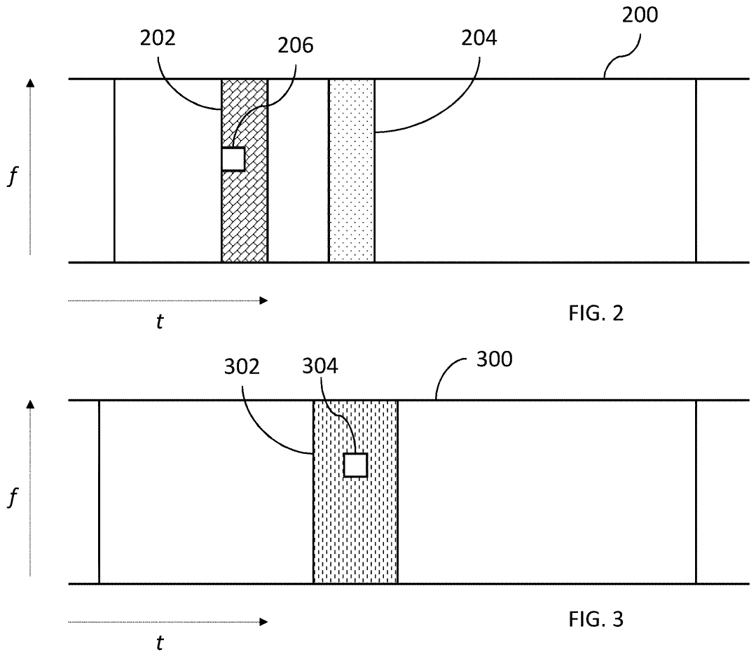

An example downlink data packet 200 is illustrated schematically in FIG. 2. The downlink packet 200 comprises control portions allocated to the NB-IoT physical downlink control channel (NPDCCH) 202 (the packet 200 may comprise multiple portions allocated to NPDCCH, only one is illustrated here). The NPDCCH 202 carries downlink control information (DCI) such as resource allocation and decoding information. The downlink packet 200 also comprises payload portions allocated to the NB-IoT physical downlink shared channel (NPDSCH) 204 (again, only one portion is illustrated here). The NPDCSH 204 carries actual user data.

A example uplink data packet 300 is illustrated in FIG. 3. The uplink data packet 300 comprises control portions allocated to the NB-IoT physical uplink shared channel (NPUSCH) format 2 302 (one example is illustrated). The NPUSCH format 2 302 carries uplink control information (UCI).

Radio signals carrying the downlink data packets 200 from the eNB 102 to the UE 104 may be subject to noise and interference and fading. The communication system 100 therefore uses a dynamic Hybrid automatic repeat request (HARQ) mechanism, in which the UE 104 can send feedback to the eNB 102 to indicate that a packet arrived correctly, or to request that the eNB 102 re-transmit an incorrectly received packet. However, because the eNB 102 is provided by a satellite, the physical distance between the eNB 102 and UE 104 may be large (e.g. 100s of km), leading to relatively long round-trip signal times. Having to wait for HARQ feedback for every packet would thus lead to the communication stalling when transmitter runs out of HARQ processes to schedule (in some examples there may only be one HARQ process available).

The communication system 100 therefore uses a dynamic HARQ feedback mechanism, in which feedback is not sent for every packet. The NPDCCH 202 of each downlink packet 200 includes a feedback request indicator field 206, which indicates to the UE 104 whether feedback is requested for the packet 200, and the time-frequency resources 304 in the NPUSCH format 2 302 of the uplink packet 300 to be used for this feedback.

The communication system 100 also facilitates the supply of regular Channel State Information (CSI) updates from the UE 104, i.e. regular reporting on the quality of the channel between the eNB 102 and the UE 104. The feedback request indicator field 206 in each downlink packet 200 indicates if a CSI update is requested, and which resources in the NPUSCH format 2 302 of the uplink packet 300 to use for this update. It is particularly useful for the eNB 102 to be able to request regular CSI updates when HARQ feedback is not regularly used, to be able to identify when channel conditions are deteriorating and additional error compensation (e.g. more regular requests for HARQ feedback and/or changing of the code rate of upcoming data packets) may be needed.

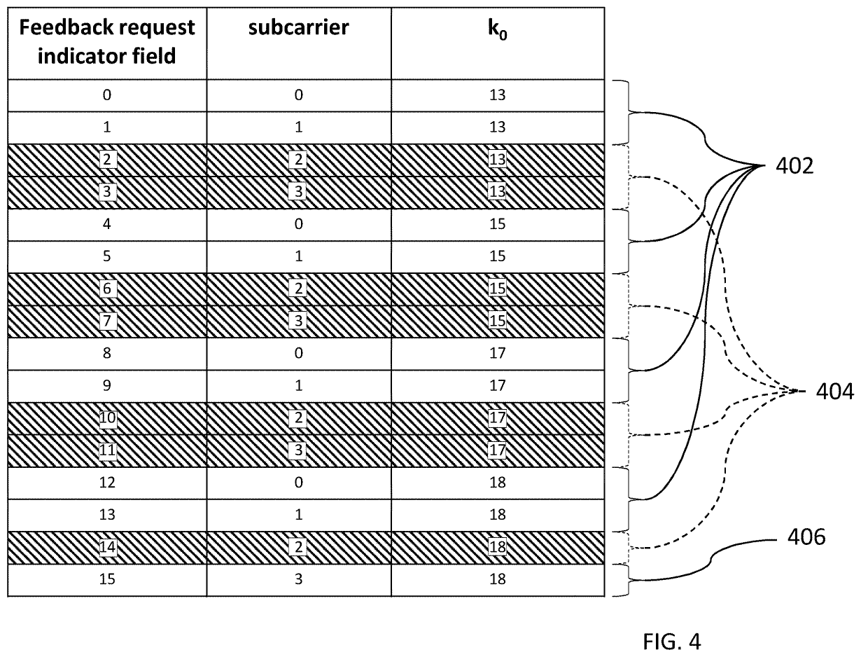

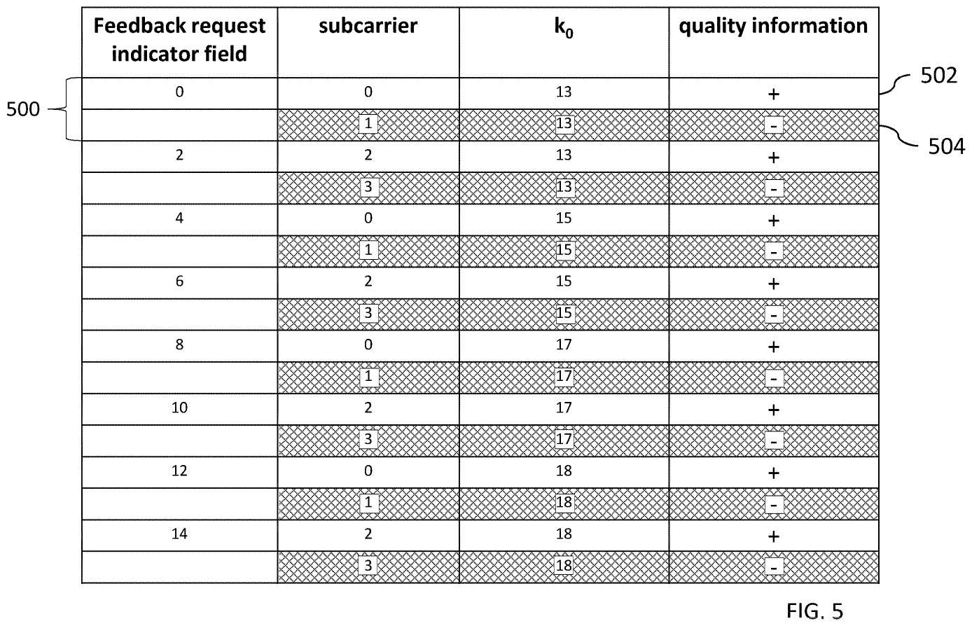

The dynamic feedback may be implemented in different ways. Two possible embodiments will now be described with additional reference to FIGS. 4 and 5. In these embodiments, the feedback request indicator field 206 is the ACK/NACK resource field in DCI Format N1. The feedback request indicator field 206 consists of four bits (i.e. having sixteen possible values). The UE 104 sends a single acknowledgement bit when HARQ feedback is requested, to indicate whether the packet was received properly (ACK) or not (NACK).

In one embodiment (illustrated in FIG. 4), the feedback request indicator field 206 can:
a) indicate that HARQ feedback is requested and specify one of eight resources in the NPUSCH format 2 302 to be used for the HARQ feedback;
b) indicate that a CSI update is requested and specify one of seven resources in the NPUSCH format 2 302 for the CSI information; or
c) indicate that no feedback is requested.

If the feedback request indicator field 206 has a value in a first set 402, this indicates that HARQ ACK/NACK feedback is requested (option (a). There are eight possible values in the first set 402 (0, 1, 4, 5, 8, 9, 12 and 13), which specify eight possible resources for the HARQ feedback in the NPUSCH format 2 302. For instance, a value of “0” indicates that a HARQ feedback bit (ACK/NACK) should be sent on subcarrier index 0 with a timing offset of k₀=13 in the NPUSCH format 2 302 of the uplink packet 300.

If the feedback request indicator field 206 has a value in a second set 404, this indicates that HARQ ACK/NACK is not requested but that a CSI update is requested (option (b)). There are seven possible values in the second set 404 (2, 3, 6, 7, 10, 11 and 14), which specify seven possible resources for the CSI report in the NPUSCH format 2 302. For instance, a value of “2” indicates that CSI report data should be sent on subcarrier index 2 with a timing offset of k₀=13 in the NPUSCH format 2 302 of the uplink packet 300.

Finally, if the feedback request indicator field 206 has a value in a third set 406, this indicates that no feedback is requested (i.e. option (c)). In this example, the third set 406 consists of a single value, “15”.

In use, the UE 104 receives a downlink data packet, detects the value of the feedback request indicator field 206 and attempts to decode the user data carried in the NPDSCH 204. In a first step of this decoding, the UE 104 assesses one or more error-detecting portions of the downlink data packet (e.g. one or more check bits or parity bits), which indicate if the data packet is sufficiently error-free for successful decoding.

If the value of the feedback request indicator field 206 is in the first set 402, the UE 104 transmits an ACK or NACK to the eNB 102, using the resources in the NPUSCH format 2 302 indicated by the value of the feedback request indicator field 206. If the decoding attempt was successful, the UE 104 transmits an ACK (e.g. a “1”) and if the decoding attempt was unsuccessful, the UE 104 transmits an NACK (e.g. a “0”).

If the value of the feedback request indicator field 206 is in the second set 404, the UE 104 does not transmit an ACK or NACK, but transmits a CSI indicator based on a recent measurement of channel quality to the eNB 102, using the resources in the NPUSCH format 2 302 indicated by the value of the feedback request indicator field 206. The CSI indicator may, for instance, by determined from a channel quality measurement based on a narrowband reference signal or a synchronisation signal received by the receiver

If the value of the feedback request indicator field 206 is in the third set 406 (i.e. if it is equal to “15”), the UE 104 simply proceeds to process the downlink data packet without transmitting any feedback to the eNB 102.

In another embodiment (illustrated in FIG. 5), the UE 104 provides HARQ ACK/NACK feedback and CSI information together. The feedback request indicator field 206 is again a four bit field that can adopt 16 values. In this embodiment, the feedback request indicator field 206 can:
a) indicate that HARQ feedback is requested and specify one of eight pairs of resources in the NPUSCH format 2 302 for a combined HARQ ACK/NACK and CSI update; or
b) indicate that no feedback is requested.

The least significant bit (LSB) of the feedback request indicator field 206 indicates whether feedback is requested or not. If the LSB is equal to 1 (i.e. if the value of the feedback request indicator field 206 is odd), the UE 104 is instructed to send no feedback (i.e. no HARQ ACK/NACK feedback and no CSI report).

If the LSB is equal to 0 (i.e. if the value of the feedback request indicator field 206 is even or zero), the UE 104 is instructed to provide HARQ feedback and a CSI update. The three remaining bits are used to specify how this feedback should be transmitted.

The three remaining bits identify one of eight pairs of resources in the NPUSCH format 2 302 to use for combined HARQ ACK/NACK and CSI feedback (if feedback is enabled). For instance, if the three remaining bits are all equal to zero, this identifies a first pair 500 of resources in the NPUSCH format 2 302 of the uplink packet 300: a first resource 502 at subcarrier index 0 with a timing offset of k₀=13 and a second resource 504 at subcarrier index 1 with a timing offset of k₀=13.

To UE 104 sends combined HARQ ACK/NACK and CSI feedback by transmitting the HARQ feedback (e.g. a “0” or “1”) at the resource of the specified pair that corresponds to a desired CSI report. If the channel quality is increasing, the UE 104 sends the HARQ feedback at the first resource 502 of the pair. If the channel quality is decreasing, the UE 104 sends the HARQ feedback at the second resource 504 of the pair. The eNB 102 then performs blind decoding at the appropriate position in the NPUSCH format 2 302 to identify which resource 502, 504 has been used (to identify the CSI report) and to determine the bit transmitted in said resource (to identify the HARQ feedback). Encoding the CSI feedback with the time and frequency resources used to transmit the HARQ ACK/NAK may comprise a particularly flexible use of communication resources, as two bits may be transmitted by the UE while transmitting only on a single resource. Whilst in this embodiment the amount of uplink (UL) resources used for UE feedback is increased (i.e., 2 subcarriers reserved for one UE), the overall use of UL control resources in the network may not be increased due to the fact that for most of the downlink data packets the feedback may be disabled.

In the embodiment illustrated in FIG. 5, the ACK/NACK is combined with a separate indication of whether channel quality is increasing or decreasing. In a variant of this embodiment, the ACK/NACK itself may also be used to indicate CSI information. For instance, as illustrated in Table 1 below, an ACK sent in a first resource may indicate an SNR increase of 0.5 dB and an NACK sent in the first resource may indicate an SNR decrease of −0.5 dB. An ACK sent in a second resource may indicate a larger SNR increase of 2 dB and an NACK sent in the second resource may indicate a larger SNR decrease of −2 dB. The CSI information indicated by a ACK/NACK in the same resource may not necessarily be symmetrical (e.g. an ACK in the first T-F resource may indicate no change in SNR, whilst a NACK in the first T-F resource may indicate −0.5 db change in SNR).

TABLE 1
using ACK/NACK to indicate CSI information

| | |
|---|---|
| First T-F resource, ACK | ACK and 0.5 dB up |
| First T-F resource, NACK | NACK and −0.5 dB |
| Second T-F resource, ACK | ACK and 2 dB |
| Second T-F resource, NACK | NACK and −2 dB |

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A receiver device arranged:
to receive a data packet from a transmitter device comprising a control portion and a payload portion, said control portion comprising a feedback request indicator;
to detect the feedback request indicator;
to attempt to decode the payload portion of the data packet;
to transmit an acknowledgement to the transmitter device if said feedback request indicator indicates that an acknowledgement is requested for said data packet; and
to process said data packet without transmitting an acknowledgement if said feedback request indicator indicates that an acknowledgement is not requested for said data packet.

2. The receiver device as claimed in claim 1, arranged to transmit a positive acknowledgement to the transmitter device if said feedback request indicator indicates that an acknowledgement is requested for said data packet and said attempt to decode the payload portion is or will be successful.

3. The receiver device as claimed in claim 1, arranged to transmit a negative acknowledgement to the transmitter device if said feedback request indicator indicates that an acknowledgement is requested for said data packet and said attempt to decode the payload portion is or will be unsuccessful.

4. The receiver device as claimed in claim 1, wherein the acknowledgement comprises a hybrid automatic repeat request acknowledgement.

5. The receiver device as claimed in claim 1, comprising a terrestrial device arranged to receive data packets from a transmitter device provide by a satellite.

6. The receiver device as claimed in claim 1, wherein the data packet comprises an Orthogonal Frequency Division Multiplexing packet made up of symbols spanning a plurality of time slots and frequency subcarriers.

7. The receiver device as claimed in claim 6, comprising LTE NB-IoT User Equipment.

8. The receiver device as claimed in claim 6, wherein the control portion comprises an LTE physical downlink control channel and the feedback request indicator comprises an ACK/NACK field of DCI format N1.

9. The receiver device as claimed in claim 1, wherein the feedback request indicator specifies time and/or frequency resources with which the acknowledgement is to be transmitted.

10. The receiver device as claimed in claim 9, wherein the receiver device is arranged to interpret a range of time and/or frequency resources specified by the feedback request indicator as an indication that feedback is not requested.

11. The receiver device as claimed in claim 1, arranged:
to determine channel quality information regarding a communication channel between the transmitter device and the receiver device; and
to transmit said channel quality information to the transmitter device if said feedback request indicator indicates that channel quality information is requested.

12. The receiver device as claimed in claim 11, wherein the channel quality information comprises a plurality of bits encoded using orthogonal cover coding on a bit or symbol sequence sent to the transmitter.

13. The receiver device as claimed in claim 11, wherein the feedback request indicator specifies time and/or frequency resources with which the channel quality information is to be transmitted.

14. The receiver device as claimed in claim 11, arranged to encode the channel quality information with time and/or frequency resources used to transmit the acknowledgement.

15. The receiver device as claimed in claim 14, arranged to transmit the acknowledgement using a first set of time and/or frequency resources to indicate a first channel quality indication and to transmit said acknowledgement using a second set of time and/or frequency resources to indicate a second channel quality indication.

16. A communication system comprising:
a transmitter device; and
a receiver device;
wherein the transmitter device is arranged to:
transmit a data packet to the receiver device, said data packet comprising a control portion and a payload portion, said control portion comprising a feedback request indicator; and
wherein the receiver device is arranged:
to receive said data packet from the transmitter device;
to detect the feedback request indicator;
to attempt to decode the payload portion of the data packet;
to transmit an acknowledgement to the transmitter device if said feedback request indicator indicates that an acknowledgement is requested for said data packet; and
to process said data packet without transmitting an acknowledgement to the transmitter device if said feedback request indicator indicates that an acknowledgement is not requested for said data packet.

17. A method of operating a communication system, said method comprising:
a transmitter device transmitting a data packet to a receiver device, said data packet comprising a control portion and a payload portion, said control portion comprising a feedback request indicator; and
the receiver device:
receiving said data packet;
detecting the feedback request indicator;
attempting to decode the payload portion of the data packet;
transmitting an acknowledgement to the transmitter device if said feedback request indicator indicates that an acknowledgement is requested for said data packet; and
processing said data packet without transmitting an acknowledgement to the transmitter device if said feedback request indicator indicates that an acknowledgement is not requested for said data packet.

18. The receiver device as claimed in claim 9, wherein the receiver device is arranged to interpret a range of time and/or frequency resources specified by the feedback request indicator as an indication that an acknowledgement is not requested.

19. The communication system as claimed in claim 16, wherein the feedback request indicator specifies time and/or frequency resources with which the acknowledgement is to be transmitted and the receiver device is arranged to interpret a range of time and/or frequency resources specified by the feedback request indicator as an indication that an acknowledgement is not requested.

20. The method of operating a communication system as claimed in claim 17, wherein the feedback request indicator specifies time and/or frequency resources with which the acknowledgement is to be transmitted and the method comprises the receiver device interpreting a range of time and/or frequency resources specified by the feedback request indicator as an indication that an acknowledgement is not requested.
